(19) United States
(12) Patent Application Publication
(10) Pub. No.: US 2006/0080874 A1
(43) Pub. Date: Apr. 20, 2006

(54) Dynamic message sign

(76) Inventor: Arnold Eberwein, Meerbusch (DE)

Correspondence Address: 3M INNOVATIVE PROPERTIES COMPANY, PO BOX 33427, ST. PAUL, MN, 55133-3427, US

(21) Appl. No.: 10/967,622

(22) Filed: Oct. 18, 2004

(51) Int. Cl. G09F 13/04

(52) U.S. Cl. 40/564

(57) ABSTRACT

The illuminated message sign comprises a light emitting device, a translucent retro-reflective film arranged to be illuminated by said light emitting device, and indicia, wherein said indicia are arranged in front of said translucent retro-reflective film. The indicia comprise at least an active part adapted for dynamically displaying variable information and may further comprise a passive part adapted for displaying invariable information.

The present invention relates to a dynamic message sign or display and, in particular, to a backlit message sign or display for dynamically displaying variable information.

Illuminated message signs are commonly known. The illuminated signs can be either frontlit or backlit. Frontlit message signs typically include such signs as billboards or other displays where the light is shone from the perimeter of the sign at an angle toward the sign.

Backlit message signs typically have a translucent surface through which the light is seen and on which the message or display is placed. Uniformity of light emanating from the translucent surface is important. Therefore, the translucent surface often includes some element that diffuses the light to reduce the identification by the viewer of the light source within the sign housing. However, such diffusing elements absorb a big portion of the light emitted by the light source. In order to provide sufficient luminance to be clearly visible to the viewer, a light source used in known backlit message signs has to be powerful. In order to provide sufficient luminance and to distribute the light emitted by the light source as uniformly as possible inside the housing, several light sources are often used. In order to provide enough space for such powerful light sources, known backlit message signs generally exhibit a large back depth. Therefore, a disadvantage of known backlit message signs is high material consumption. Furthermore, due to the presence of several light sources, known backlit message signs suffer from high power consumption and produce a substantial amount of heat.

Active displays for dynamically displaying variable information are generally known. In U.S. Pat. No. 5,394,308 a lightening apparatus for illuminating a liquid crystal display (LCD) panel from behind is disclosed which, when illuminated uniformly, exhibits asymmetric contrast ratios as viewed in a vertical direction. A background lighting apparatus for liquid crystal display is also disclosed in U.S. Pat. No. 5,667,289. The apparatus described therein comprises a light entering edge surface around substantially the entire periphery of a highly internally reflecting transparent plate and a distributed diffusion system to diffuse and reflect light entering the interior of said plate. The diffusion system includes a pattern of diffusion elements whose area ratio is greatest at the center of the pattern. The diffusion system of the lighting apparatus thus shows a complicated structure. In particular, it is difficult to achieve balanced illumination of the transparent plate.

U.S. Pat. No. 5,452,532 discloses a roadsign for presenting a customisable message to the driver under direct and backlighting conditions, message elements and background elements being placed into appropriate mounting holes to form a mosaic message, wherein each mosaic has a retro-reflective portion surrounded by a translucent border. Due to the large size of the message elements, the resolution of the display is poor. Furthermore, the separation of the retro-reflective part and the translucent part results in a complex structure and efficiency problems. When the driver approaches the roadsign only a portion of each element will be illuminated which leads to phantom effects.

Despite the known illuminated signs, there continues to be a need to provide further illuminated message sign. Preferably, these signs have improved and advantageous properties.

The present invention provides an active illuminated message sign for dynamically displaying variable information which may be combined with a passive part for displaying invariable information. The message sign has an improved luminance efficiency and reduced power consumption. Furthermore, the invention may provide redundancy through retro-reflective back-up after a power failure for both the active and passive display elements. Accordingly, even upon a power failure, the sign may still provide useful information to the user. Moreover, the message sign provides the possibility to control the active part in such a way that a default message is displayed in case of a power failure, e.g., a preprogrammed message informing the viewer that the sign is our of order.

The illuminated message sign comprises a light emitting device, a translucent retro-reflective film arranged to be illuminated by said light emitting device, and indicia, wherein said indicia are arranged in front of said translucent retro-reflective film. The indicia comprise at least an active part adapted for dynamically displaying variable information and may further comprise a passive part adapted for displaying invariable information.

In the message sign according to the present invention, the light emitting device may comprise a light source and a light guide which can be hollow or solid. The light emitting device may also comprise a large surface light source, like a self-emissive light source based on inorganic electro luminescence (IEL) or organic light emitting diode (OLED) technology. The construction and functioning of such OLEDs are described, e.g., in the online-magazine Schott Info 99/2001.

The amount and distribution of light extracted out of the front face of the light guide can be enhanced by providing a back reflector arranged at the back face and/or at the side faces of the light guide or the self-emissive light source. Both the back reflector and the side face reflectors preferably are diffuse reflective, specular reflective, or scattering reflective films with high reflection efficiency. Arranging reflectors and, in particular, highly diffuse or specular or scattering reflective films along the back and/or side faces of the light guide provides for a light guide in which the light can escape substantially exclusively through the front face so that most of the light of the light source can be used for illuminating the indicia. Accordingly, such a design is highly efficient with regard to the required brightness, uniform illumination, and power consumption.

In the case of a hollow light guide, said light guide preferably comprises a cavity having major front and back faces. The front face is defined as the face of the cavity which is directed at the viewer while the back face is arranged substantially opposite to the front face, and away from the viewing direction. The front and back faces can have any suitable shape, like square, rectangular, polygonal or circular. The translucent retro-reflective film is arranged at at least a portion of the front face and the reflector is arranged at at least a portion of the back face. Preferably, the retro-reflective film covers substantially the whole front face of the cavity. The reflector preferably covers substantially the whole back face of the cavity. The light source is arranged inside the cavity, and preferably centrally with respect to the vertical and/or horizontal dimension of the front face of the cavity. Within the cavity, light is transmitted by multiple reflections at the front, back and optional side faces until the light rays impinge onto the front face and onto the translucent retro-reflective film at an angle at which the light is transmitted out of the front face of the light guide and through the translucent retro-reflective film.

The translucent retro-reflective film can be beaded, prismatic or provided with cube corners as known to those skilled in the art. Typically any type of translucent retro-reflective film can be used. In particular, those light-transmissive retro-reflective films can be used which are used in traffic signs. For instance, the cube corner retro-reflective film as described in U.S. Pat. No. 4,588,258, U.S. Pat. No. 5,122,902 and WO-A-98/20375 is useful as the translucent retro-reflective film for the illuminated message sign according to the invention. These documents are incorporated herein by reference. The cube-corner retro-reflective films described in these references provide improved angularity along multiple viewing planes. The films may comprise at least one matched pair of cube-corner retro-reflective elements which are rotated 180° with respect to one another, the three lateral mutually perpendicular faces of the elements being defined at their bases by linear edges that lie in a common plane and the optical axes of the elements being tilted toward one another. Furthermore, the article may comprise several types of prismatic retro-reflective elements. In some embodiments, the base edges of the lateral faces of adjacent elements define separation surfaces between the bases of the elements. In other embodiments, a portion of an element is removed to define truncated surfaces on the elements. A beaded retro-reflective film comprising retro-reflective microspheres, as disclosed in the traffic sign of U.S. Pat. No. 4,005,538, can also be employed.

In front of the translucent retro-reflective film, indicia are arranged in the form of, for example, graphics and/or characters or the like. According to the invention, indicia in the general sense are all means arranged to provide information to the viewer. The indicia comprise at least an active part for dynamically displaying variable information. The active part may be operated by means of an electronically controlled shutter system, for example a dichroic LCD type and/or a twisted liquid crystal system. A modular LCD display system useful in the invention may provide display of characters, numbers and certain graphic symbols which are formed by an array of individually controlled matrix elements or elements arranged in a mosaic-like structure. While the mosaic-like elements may be specifically designed for displaying characters and numbers, the matrix elements may also be suitable to show all kinds of graphic arts. The LCD display system may be based on ETN (enhanced twisted nematic) technology wherein the contrast ratio in a specific wavelength is enhanced with respect to twisted nematic displays by using a dye doped with liquid crystal. A suitable LCD display system is the modular LCD display system available from AEG/MIS, Ulm, Germany under the trade name Geascript.

In the active part, a display system, e.g., the modular LCD display system as described above or similar display system, may form the indicia. In addition, an indicia film may be arranged between the translucent retro-reflective film and the shutter system. The indicia film in the active part may be, for example, a colored film in order to give the indicia which are displayed by a modular LCD display system as described above a colored appearance in a desired color. As an alternative or additionally, indicia may be formed on the indicia film which can be displayed or covered by the shutter system of the active part. In this way, it is possible to display alphanumeric and/or graphic information in a monochrome mode in white or in colors, in positive (black lettering, white or colored background) or in negative (white or colored lettering on black background) image.

The indicia may further comprise a passive part for displaying invariable information as generally known in the art.

Indicia can be arranged, for example by printing, directly on the translucent retro-reflective film or can be supported by an additional film (indicia film). In a preferred embodiment of the invention, the indicia film is laminated onto a transparent support film by means of a transparent optically clear adhesive. Most preferably, the adhesive has a refractive index no greater than 1.3. The translucent retro-reflective film can also be adhered to the support film. This arrangement is located in front of the light emitting device and can be removed therefrom. The light emitting device and the support film can be mechanically fastened, for example by means of a fixing bar arranged on a frame of the message sign. As an alternative, the translucent retro-reflective film can be directly provided with indicia printed thereon or applied thereto in another known manner. The indicia film and/or translucent retro-reflective film can be directly adhered to the front face of the light emitting device by means of an optically clear (transparent) adhesive which most preferably has a refractive index no greater than 1.3.

Suitable indicia films to be used in the present invention are available from 3M Company under the tradename Scotchlite™ ElectroCut™ Film Series 1170.

When the light emitting device comprises a light guide and a light source, the light source may be an elongate light source emitting light substantially along its longitudinal direction and comprising an elongated luminant, like a light tube, for example a fluorescent tube, or several individual ruminants spaced from each other and/or arranged adjacent to each other along the longitudinal direction of the light source. Accordingly, the elongate light source can comprise a linear area of separate light emitting elements. The advantage of the provision of a plurality of light emitting elements arranged in a row or an array instead of a common single light source is that, in case of failure of individual light emitting elements, illumination of the message sign is still provided.

The message sign according to the present invention may be used, for example as traffic sign or traffic information board, as an airfield sign, or as advertisement sign or the like. The message sign according to the invention which combines active and passive display elements is particularly useful in multi-story car parks or as car park information board.

The present invention provides a message sign with a unique, slim design and nearly 180° legibility. The message sign provides a redundant system after a power failure by combining back-lighting with retro-reflective features for both the active and passive display elements. The luminance efficiency is significantly improved compared with known backlit message signs, and thus, the power consumption is substantially reduced. The message sign is cost competitive and even has an increased cost-benefit ratio with respect to current backlit systems. The lamp maintenance cycles can be strongly reduced or even eliminated if new generation lamps are used with rated life times from 30.000 hours, for example Aura® Long Life Light fluorescent lamps available from Aura Light AB, Karlskrona, Sweden, up to 50.000 hours, for example cold cathode fluorescence lamps (CCFL) as well as latest LED light sources arranged in a row or an array. Additional energy savings can be gained when using new generation lamp electronics.

A further advantage of the message sign according to the present invention is that the active display modules can also be implemented into non-lit signs, in particular non-backlit signs. It is possible to implement active display modules in existing signs which may be lit or not lit. Furthermore, sign makers or converters can use their own stock materials. Due to the reduced size of the housing of the message sign, smaller aluminium extrusions can be used, thereby saving cost and weight.

In the following, preferred embodiments of the invention will be explained in greater detail with reference to the accompanying drawings. In the drawings

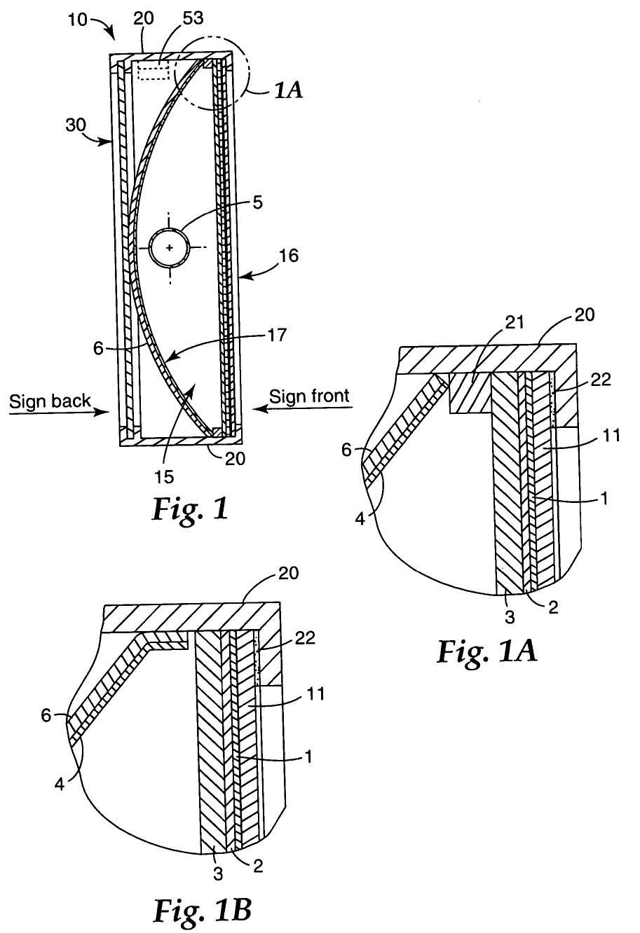

FIG. 1 is a cross sectional view through a message sign according to a first embodiment of the invention comprising a hollow light guide,

FIG. 1A is an enlarged view of the portion of the message sign which is encircled and denoted 1A in FIG. 1,

FIG. 1B is an alternative embodiment of FIG. 1A,

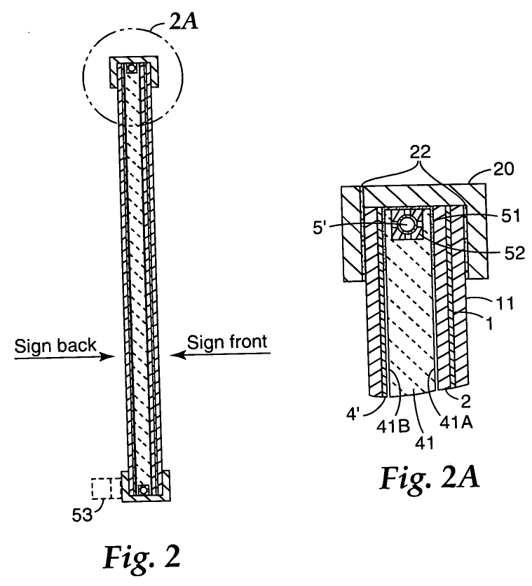

FIG. 2 is a cross sectional view through a message sign according to a second embodiment of the invention comprising a solid light guide,

FIG. 2A is an enlarged view of the portion of the message sign which is encircled and denoted 2A in FIG. 2,

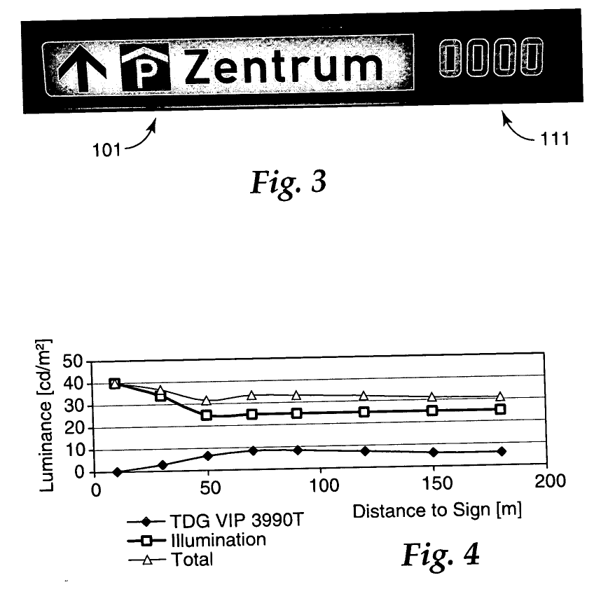

FIG. 3 is a photograph of the front face of a message sign according to the present invention and

FIG. 4 is a graph showing the dependency of the luminance of a message sign according to the present invention on the distance of a viewer to the sign.

Throughout the drawings like elements and parts of the different embodiments of the invention are referred to by like reference numerals.

In FIGS. 1, 1A and 1B, a first embodiment of a message sign according to the invention is shown in a cross-sectional view in greater detail. A frame 20, which together with a rear wall 30 forms the housing 10 of the message sign, is made of aluminium extrusion or plastic or other suitable materials. Inside the housing, a cavity 15, comprising a front face 16 and a back face 17, is formed. Inside the cavity 15, a light source 5 is arranged. In the embodiment shown in FIG. 1, the light source 5 is an elongate light source, like a fluorescent lamp, for example, a fluorescent lamp with long rated lifetime, like an AURA® fluorescent lamp, or a cold cathode fluorescent lamp (CCFL). However, other suitable light sources may be used. On the back face 17 of the cavity, a highly specular or diffuse reflector that comprises a specular or diffuse reflective layer 4 and a support layer 6 is arranged. In FIG. 1, back face 17 carrying the reflector 4 is bent so that the light which is emitted from the light source 5 in the direction of the back face 17 of the cavity 15, is redirected towards the front face 16. The lamp electronic 22 can be arranged inside the housing 10 in the unused space between the reflector 4 and the rear wall 30.

As an alternative, the reflector may be arranged along the back face and side faces of the housing so that the housing 10 forms the cavity.

The back reflector is preferably comprised of a film. For example, such a film is available from 3M Company, St. Paul, USA, under the tradename Radiant Mirror Film VM 2000, VM 2002 or VM 2000 F1A6, or Light Enhancement Film 3653-100. With the above arrangement, substantially all the light emitted from the light source 5 can exit only through the front face 16 of the cavity 15 for creating an illuminated side of the light guide.

The light source may alternatively comprise a plurality of light emitting diodes (LEDs) arranged in an array or cluster on the rear wall 30 of the housing 10 or on a separate layer between the rear wall 30 and the front face 16 of the cavity 15. In this case, the reflective film may be arranged between the LEDs. Furthermore, a solar reflective film can be arranged on the front face 16 which reflects infrared solar energy while transmitting visible light. Such a film thus reduces heating-up of the cavity 15 due to solar irradiation, excessive heating-up could result in degraded operation or even destruction of the LEDs. A suitable solar reflective film to be used in the present invention is available, e.g., from 3M Company, St. Paul, USA, under the tradename Automotive SRF 1100.

The front face 16 of the cavity 15 is formed by a sandwich structure of several layers comprising a translucent retro-reflective film 2 and an indicia film 1. At least on a portion of the front face, a further layer 11 comprising an electronically controlled shutter system, for example a liquid crystal cell, is arranged to form the active part of the indicia. In the passive part, the indicia film 1 is provided with indicia in the form of characters, digits or graphics. In the active part, the shutter system may be used to display or to cover as desired the indicia provided on the indicia film 1. Alternatively, a modular LCD display system (e.g. the “Geascript” branded modular LCD display system available from AEG/MIS Company, Ulm, Germany) may be used, wherein a mosaic or matrix structure of LCD elements allows to display individual information, such as characters, numbers and/or graphics. A colorized appearance of the displayed information using the modular LCD system can be provided by arranging a colored indicia film 1 having a desired color underneath the LCD system in the regions where the displayed~information should appear in the desired color.

The translucent retro-reflective film 2 can be a beaded or prismatic, or preferably a cube corner film as known to those skilled in the art. Preferably, a cube corner film is used. Such a film to be used in the present invention is available from 3M Company, St. Paul, USA under the tradename Scotchlite™ Diamond Grade™ Translucent Reflective Sheeting 3990 T. The retro-reflective properties of this film are used both for external light impinging on and through the indicia film 1 as well as internal light from the light emitting device. In the latter case, the translucent retro-reflective film 2 together with the back reflector (support layer 6 and reflector layer 4) provides for multiple light reflections through the cavity 15 resulting in a homogenous illumination of the front face of the cavity. Light rays emitted from the light source impinging on the translucent retro-reflective film 2 at angles within a certain range, e.g., from about −45° to +45° relative to a line perpendicular to the film, are back-reflected due to the optical properties of the translucent retro-reflective film 2. Therefore, the light source can be arranged close to the translucent retro-reflective film 2 without destroying the uniformity of the illumination. This allows improved luminance at that distances of the viewer to the sign, as shown in FIG. 4 discussed below.

As an alternative for a separate indicia film 1, the indicia can be printed directly onto the translucent retro-reflective film 2. In the active part, when using a display system, like a modular LCD display system to form the indicia a colored translucent retro-reflective film can be used to provide the indicia with a desired color, instead of providing a colored indicia film.

In the embodiment shown in detail in FIG. 1A, a cover layer 3 is provided to keep the sandwich structure comprising the translucent retro-reflective film 2, the indicia film 1 and the shutter system 11 in an adjacent position. The cover layer may be made of glass or a transparent plastic, for example GE-Lexan® available from GE Structured Products, Pittsfield, USA. Alternatively, the retro-reflective film 2 and the indicia film 1 may be adhered to each other and to the shutter system 11 by means of light-transmissive adhesive 6, e.g. stretch-release type VP 5290 available from 3M Company, St. Paul, USA, as shown in detail in FIG. 1B. Moreover, a sealing film 22 can be provided between the frame 20 and the outermost layer of the sandwich structure in order to protect the cavity against contamination by dust, humidity or the like.

The sandwich structure comprising the different layers as mentioned above is mechanically fixed to form the front face of the cavity by any suitable mechanical fastening means such as clamps or the like. In the embodiment shown in FIG. 1, the housing 10 comprising the rear wall 30 and the frame 20 projecting therefrom encompasses the cavity 15, the light source 5, and the layers of the sandwich structure. The layers of the sandwich structure are fastened between a front portion of the frame 20 and a fixing bar 21. The frame 20 defines an opening within which the front face of the cavity is exposed. The frame 20 can be secured to the rear wall 30 by any suitable means like screws, clamps or the like allowing the assembly of the message sign.

A second embodiment of a message sign according to the invention is shown in cross-sectional view in FIGS. 2 and 2A. The differences between the message sign according to the second embodiment and the message sign according to the first embodiment of FIG. 1 relate to the construction of the light guide. According to FIG. 2, the message sign comprises a solid light guide 41 made of a transparent synthetic material, for example, acrylic, e.g. polymethylmetacylate or polycarbonate, and having a plate-like shape. The solid light guide 41 essentially replaces the substantially empty space between the front and back face of the cavity of the first embodiment shown in FIG. 1.

The light guide 41 comprises a major front face 41a and an opposite major back face 41b as well as opposite side faces. The light source 5′ is arranged along at least one of the side faces (in the embodiment shown in FIG. 2 along the upper and lower side face 20 of the light guide). The light source 5′ may be an elongate light source, for example, a linear lamp such as a cold cathode fluorescent lamp (CCFL). The lamp may be fixed to the light guide using spots 52 of clear, UV-resistant silicone. Alternatively, the elongate light source may comprise a printed circuit board or the like carrier strip carrying several LEDs arranged side by side for forming a linear array. The light source 5′ provides for edge illumination of the solid light guide 41.

Along the side faces of the light guide 41 and on a portion of the front and back faces 41a, 41b of the light guide adjacent to the light source 5a, highly specular or diffuse reflector 51 is provided which acts as a lamp reflector. This reflector is adhered to the light guide 41 by means of an optically clear (transparent) adhesive, preferably having a refractive index no greater than 1.3. Other optically clear adhesives can also be used. Suitable adhesives are available from 3M Company, Saint Paul, USA (e.g., #8141, #8142, #8161 or #9483). A highly diffuse or specular back reflector 4′ is arranged to face the back face 41b of the light guide 41. The back reflector 4′ as well as the lamp reflector 51 are comprised of the same materials and serve the same purpose as the back reflector 4 of the first embodiment of the invention shown in FIG. 1.

In order to further improve the uniformity of the illumination of the front face of the light guide 41, the light guide 41 can be provided with light scattering particles substantially homogenously distributed within the material of the light guide 41 and having different light diffractive properties.

In an alternative embodiment of the message sign according to the invention using a solid light guide, the solid light guide has a wedge-like shape comprising a narrow side face and an opposite wide side face wherein the light source is arranged along the wide side face of the solid light guide. This tapered embodiment of the solid light guide provides the advantage that within the narrow portion, i.e. the portion spaced from the light source, the number of reflections at the back face of the light guide is increased which compensates for the decreasing intensity of the reflected light. Therefore, when that the light source is arranged along at least a portion of only one of the side faces, the tapered configuration provides a more equal distribution of the light.

In the second embodiment of the invention, the translucent retro-reflective film 2 with the indicia film 1 may be directly adhered to the front face of the solid light guide 41 by means of an adhesive layer. This adhesive layer can preferably be of the stretch-release type adhesive tape VP 5290 available from 3M Company, St. Paul, USA. However, other optically clear adhesives can be used as well. The adhesive should be capable to be peeled off from the light guide 41 without residuals left on the front face of the light guide so that the indicia film 1 and translucent retro-reflective film 2 can be replaced by another combination of indicia film and translucent retro-reflective film.

FIG. 3 shows a photograph of the front face of a message sign according to the present invention. In the example shown in FIG. 3, the message sign is a car park information board comprising a passive part 101 and an active part 111. In the passive part, invariable information like the name and the route to a parking garage is displayed, whereas the active part 111 displays variable information such as the number of free parking places in the parking garage. Furthermore, message sign according to the invention can be used, e.g., as parking lot indication signs, directional signs for highways, driver feedback signs, e.g. signs displaying the actual speed of a car, or traffic signs and traffic information boards. Other applications of active message boards or message boards combining active and passive parts, like traffic signs being remotely operated by cable, radio or GPS/GMS communication system connected to, for example, a traffic management control, are also contemplated.

The new active display module according to the present invention can be implemented into a standard retro-reflective—but non-illuminated—sign or information board as well as in a trans-illuminated and retro-reflective sign or information board. The message sign of the invention has great benefit in traffic safety because of the unique combination of illuminated and retro-reflective sign features within one dynamic traffic sign or information board. With the message sign of the invention sign legibility is never critical at any sign distance or viewing angle.

The luminance of a message sign according to the present invention with respect to the distance of the viewer to the sign is shown in FIG. 4. The luminance values have been determined as follows:

The curve marked as TGD VIP 3990T was determined with two sets of general optical measurements and subsequently the dependence on the distance was calculated. The first set of measurements used a right headlamp of a used VW Passat car measured by LMT GOH (photo goniometer) with a voltage of 13.0 Volts measured at the lamp socket. The luminous intensity was determined over horizontal and vertical angular ranges that typically occur for these applications (±5-15 degrees).

The second set of measurements was obtained by measuring the relative portions retro-reflected by the Scotchlite™ Diamond Grade™ Translucent retro-reflective sheeting TDG VIP 3990T again over three angular ranges, namely the vertical and horizontal angle with respect to the axis perpendicular to the surface of the sheeting and the angle between the incident and the retro-reflected beam.

The curve as shown in FIG. 4 was then obtained by calculating the luminance for the distances in the range from 0 to 200 m. The luminance as such is not dependant on the distance, however, for each distance between the sign and the vehicle different angles occur determined from the fact that the sign as such is 10 m offset from the street and at a height of 3 m resulting in varying angles for each distance between the sign and the vehicle. These angles significantly increase if the vehicle approaches the sign as then the offset of the sign becomes substantial and, therefore, the retro-reflection practically approaches zero.

For the illumination curve the following approach was taken: The sign was chosen so that a luminance of 25 cd/m² was obtained when measuring in a direction perpendicularly to the surface of the sign, i.e., at vertical and horizontal angles of zero. The relative luminance was then measured as a function of the distance using a telephotometer, e.g. PR 650 Spectra Colorimeter from Photo Research in Chatsworth, Calif., USA. These measurements provide the form of the curve which then was set at 25 cd/m² for a distance of 200 m, corresponding to the fact that the luminance of the sign was chosen to have this value. Due to the fact that inside the sign the light is not reflected back at angles exceeding 45 degrees, a significant increase of the illumination is obtained above these angles and thus also at distances between the sign and the vehicle below 50 m.

The total curve is an addition of the two above curves and shows that, unlike merely retro-reflective signs, the sign according to the invention provides higher luminance at small distances between the sign and the vehicle.

Although the invention has been described and illustrated with reference to specific illustrative embodiments thereof, it is not intended that the invention be limited to those illustrative embodiments. Those skilled in the art will recognize that variations and modifications can be made without departing from the true scope of the invention as defined by the claims that follow. It is therefore intended to include within the invention all such variations and modifications as fall within the scope of the appended claims and equivalents thereof.

1. An illuminated message sign comprising
a light emitting device,
a translucent retro-reflective film arranged to be illuminated by said light emitting device, and
indicia, wherein said indicia are arranged in front of said translucent retro-reflective film and comprise at least an active part adapted for dynamically displaying variable information.

2. The sign according to claim 1, wherein said light emitting device comprises a light source and a light guide having opposite major front and back faces.

3. The sign according to claim 2, further comprising a back reflector arranged at said back face of said light guide, said back reflector preferably being a diffuse reflector or a specular reflector or a scattering reflector.

4. The sign according to claim 2, wherein said light guide is a hollow light guide comprising a cavity having said major front and back faces, said translucent retro-reflective film being arranged at at least a portion of said front face and said back reflector being arranged at at least a portion of said back face.

5. The sign according to claim 4, wherein said light source is arranged inside the cavity and preferably centrally with respect to the vertical and/or horizontal dimensions of said front face of said cavity.

6. The sign according to claim 2, wherein said light guide is a solid light guide.

7. The sign according to claim 6, wherein said light guide has side faces arranged between said major front and back faces, and said light source is arranged along at least a portion of at least one of said side faces of said solid light guide for illuminating said solid light guide.

8. The sign according to claim 2, wherein said light source comprises a plurality of light emitting elements arranged, e.g., in a row or an array.

9. The sign according to claim 1, wherein said light emitting device is a self-emissive light source.

10. The sign according to claim 1, wherein said indicia further comprise a passive part adapted for displaying invariable information.

11. The sign according to claim 1, wherein said active part of said indicia comprises an electronically controlled shutter system.

12. A method of displaying alphanumeric and/or graphic information using the sign of claim 1.

13. The method according to claim 12, wherein variable information to guide traffic is dynamically displayed.
